(19) United States
(12) Patent Application Publication
(10) Pub. No.: US 2007/0105498 A1
(43) Pub. Date: May 10, 2007

(54) Call forwarding to wireless headset

(75) Inventors: Ville Steudle, Turku (FI); Henri Heimonen, Farnborough (GB)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/269,162

(22) Filed: Nov. 7, 2005

(51) Int. Cl. H04B 7/00

(52) U.S. Cl. 455/41.2

(57) ABSTRACT

An apparatus for routing a call between a mobile phone and a wireless headset is disclosed. The apparatus has a forwarding unit for routing the call between the mobile phone and the wireless headset via a short-range wireless communications network when said wireless headset is out of a range of a short-range radio transceiver of the mobile phone. The mobile supervises the low-power radio connection between the headset and notices when the headset is out of the range and forwards the call accordingly.

### TECHNICAL FIELD OF THE INVENTION

The invention concerns an apparatus for routing a call between a mobile phone and a wireless headset. Furthermore, the invention concerns a mobile phone and a network element comprising the apparatus. Yet furthermore, the invention concerns a system for routing a call between the mobile phone and the wireless headset. Yet furthermore, the invention concerns the use of such apparatuses and systems.

### BACKGROUND ART

Wireless connectivity between a mobile phone and a hands free device, for example a wireless headset, is one of the areas that mobile phone manufacturers are developing today. Bluetooth offers a reasonable technology platform for wireless headset connection between the mobile phone and the headset. One of the basic ideas with this kind of system is to provide ease of use for mobile users. For example, user can leave his mobile phone freely on the desk, in his coat pocket or handbag, etc., and still be able to walk & talk by the mobile phone. Thus the user can use the headset for talking and listening, which headset is in short-range wireless communications between the mobile phone.

Currently, this possibility is quite limited. In a known solution, user doesn't have to be very far away to loose the connection between the mobile phone and the wireless headset.

Thus freedom with a current wireless short-range headset (e.g. a Bluetooth headset) is quite limited. The range of the short-range radio headset (and also the range of short-range radio transmitter of the mobile phone) is some 10-20 meters with known solutions. The short-range radio technology, alternatively referred to as a low-power radio technology, typically Bluetooth provides synchronous connection oriented (SCO) links capable of delivering about 64 kilobytes per second (KPS) channels to active clients. The data communications can include voice. However, because the coverage of the short-range wireless communications connection between the mobile phone and the headset is very limited, the connection is lost when the headset is out of the range.

### SUMMARY OF THE INVENTION

It is therefore the object of the invention to maintain the communications between the mobile phone and the headset when the headset is out of the range.

In accordance with an aspect of the invention there is being provided an apparatus for routing a call between a mobile phone and a wireless headset, the apparatus comprising a forwarding unit for routing said call between said mobile phone and said wireless headset via a short-range wireless communication network when said wireless headset is out of a range of a short-range radio transceiver of said mobile phone.

In accordance with another aspect of the invention there is being provided a system for routing a call between a mobile phone and a wireless headset, the system comprising: the mobile phone for detecting a short-range wireless connection between said mobile phone and said wireless headset; a short-range wireless communications network for coupling said call between said mobile phone and said wireless headset; and a forwarding unit for routing said call between said mobile phone and said wireless headset via said short-range wireless communication network when said wireless headset is out of a range of said short-range radio connection.

Various embodiments of the invention give a possibility to leave the phone on the desk or in the pocket for example when coming to office. It is not necessary to carry the (possibly big) mobile phone with all the time, while still being able to receive and initiate (with aids like a voice dialling function in the mobile phone) calls. The versatility and intelligence of the connection between the phone and the headset can be used more efficiently to improve the user experience and comfort.

Various further embodiments provide extended freedom for users. The user can receive calls within the short-range network, like inside the office, not depending if he is carrying the phone with him or not. Carrying a small wireless headset is much more convenient.

Yet further embodiments of the invention have been specified in the dependent claims.

### BRIEF DESCRIPTION OF THE DRAWINGS

The invention will now be described, by way of examples only, with reference to the accompanying drawings, in which:

FIG. 1 depicts an example where a mobile phone and a wireless headset are located so that a short-range wireless radio connection between the phone and the headset is direct in accordance with various further embodiments of the invention,

FIG. 2 depicts an example, where a mobile phone and a headset have no direct short-range radio connection and the connection is routed between the phone and the headset via a short-range wireless communications network in accordance with various further embodiments of the invention, and

FIG. 3 depicts a further embodiment of the invention where a computer with add-on short-range wireless radio transceivers and software serve as base stations for the short-range wireless communications network.

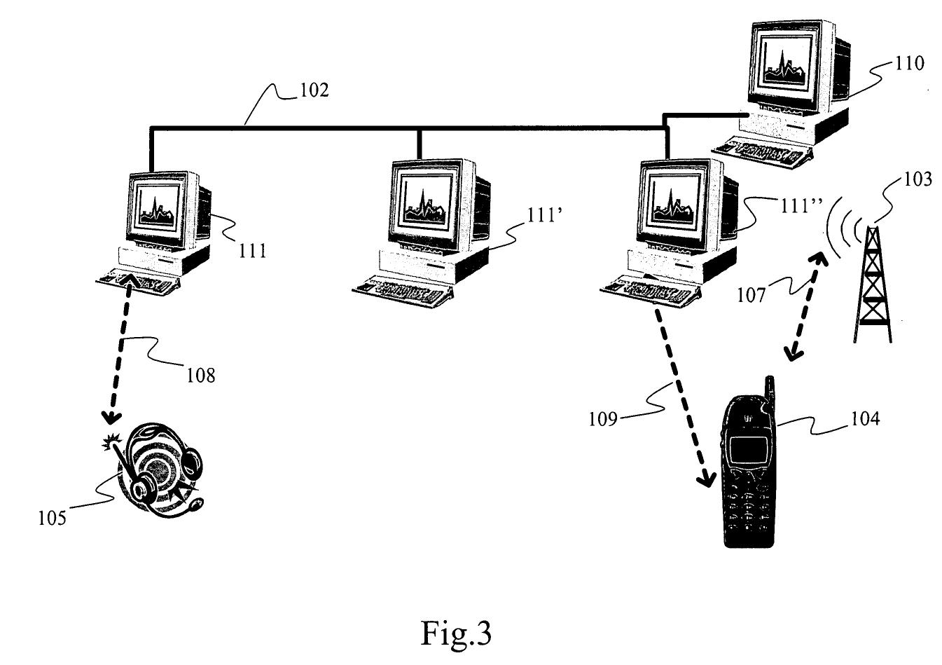

### DESCRIPTION OF FURTHER EMBODIMENTS

A brief description of short-range wireless communications, networks, systems and technique is believed appropriate before describing various further embodiments. Alternatively, the short-range wireless communications technique can be referred to as a low-power radio communications technique.

Short-range wireless communications systems have a typical range of one hundred meters or less. They often combine with systems wired to the Internet to provide communication over long distances. The category of short-range wireless systems includes wireless personal area networks (PANS) and wireless local area networks (LANs). They have the common feature of operating in unlicensed portions of the radio spectrum, usually either in the 2.4 GHz Industrial, Scientific, and Medical (ISM) band or the 5 GHz Unlicensed-National Information Infrastructure (U-NII) band. Wireless personal area networks use low cost, low power wireless devices that have a typical range of ten meters. The best-known example of wireless personal area network technology is the Bluetooth Standard, which operates in the 2.4 GHz ISM band. It provides a peak air link speed of one Mbps and a power consumption low enough for use in personal, portable electronics such as PDAs and mobile phones. The Bluetooth Special Interest Group, Specification of The Bluetooth System, Version 1.0B, Volumes 1 and 2, December 1999, describes the principles of Bluetooth device operation and communication. The preferred embodiment will be described in terms of the Bluetooth Standard. Furthermore the higher power classes of Bluetooth can communication by a range of 10 m even up to dozens of meters.

Briefly, Bluetooth devices are designed to find other Bluetooth devices within their ten-meter radio communications range and to discover what services they offer, using a service discovery protocol (SDP). The SDP searching function relies on links being established between the requesting Bluetooth device in a client role and the responding Bluetooth device in a server role. Once a link has been established, it can be used to find out about services in the responding Bluetooth device and how to connect to them.

A connection between two Bluetooth devices is initiated by an inquiring device sending out an inquiry message searching for other devices in its vicinity. Any other Bluetooth device that is listening by means of conducting an inquiry scan, will recognize the inquiry message and respond. The inquiry response is a message packet containing the responding device's Bluetooth Device Address (BD_ADDR). A Bluetooth device address is a unique, 48-bit IEEE address that is electronically engraved into each Bluetooth device.

The inquiring device uses the information provided in the inquiry response packet, to prepare and send a paging message to the responding device. To establish a connection, the inquiring device must enter the page state. In the page state, the inquiring device will transmit initial paging messages to the responding device using the access code and timing information acquired from the inquiry response packet. The responding device must be in the page scan state to allow the inquiring device to connect with it. Once in the page scan state, the responding device will acknowledge the initial paging messages and the inquiring device will send a paging packet that provides the clock timing and access code of the inquiring device to the responding device. The responding device responds with a page acknowledgment packet. This enables the two devices to form a connection and both devices transition into the connection state. The inquiring device that has initiated the connection assumes the role of a master device and the responding device assumes the role of a slave device in a new ad hoc network piconet.

Each piconet has one master device and up to seven active slave devices. All communication is directed between the master device and each respective slave device. The master initiates an exchange of data and the slave responds to the master. When two slave devices are to communicate with each other, they must do so through the master device. The master device maintains the piconet's network clock and controls when each slave device can communicate with the master device. Members of the ad hoc network piconet join and leave as they move into and out of the range of the master device.

However, other examples of short range wireless communication networks designed for either the 2.4 GHz ISM band or the 5 GHz U-NII may incorporate the principles of the present invention and include: (1) IEEE 802.11(a) and (b) described in the IEEE 802.11 Wireless Standard, described in three parts IEEE 802.11; 802.11(a) and 802.11(b); (2) HIPERLAN Type 1 described in the publication HIPERLAN Type 1 Standard, ETSI ETS 300652, WA2 December 1997; (3) HIPERLAN Type 2 Data Link Control (DLC) Layer; Part 4. Extension for Home Environment, ETSI TS 101 761-4 V!.2.1(2000-12); (4) IEEE 802.15 Wireless Personal Area Network (WPAN) Standard; (5) Infrared Data Association Standard (IrDA); (6) the Shared Wireless Access Protocol (SWAP) standard; (7) 3GPP FDD standard; (8) UWB (wireless USB) and (9) the Multimedia Mobile Access Communication (MMAC) Systems Standard of the Japanese Association of Radio Industries and Businesses. Furthermore Bluetooth can be like IEEE wireless standard 802.15/0.15.1

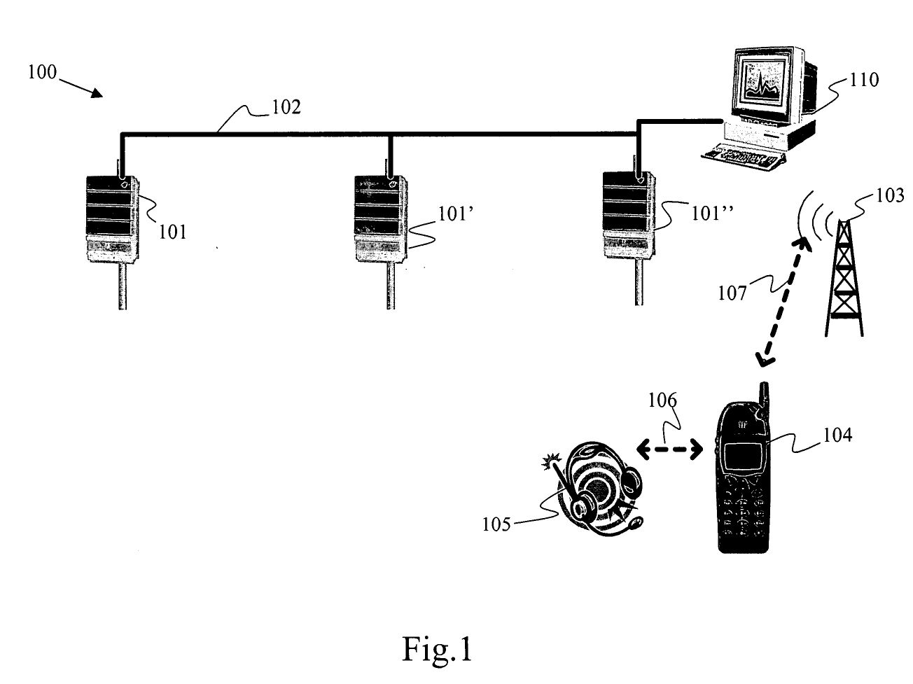

Referring now to FIG. 1, there is being depicted various further embodiments where a mobile phone 104 and a wireless headset 105 are located so that a short-range wireless radio connection 106 between the mobile phone 104 and the wireless headset 105 is direct. The mobile phone 104 communicates with the wireless headset 105 via the short-range wireless radio connection 106. In various further embodiments the short-range wireless radio connection 106 is a Bluetooth or the like connection. The mobile phone 104 is coupled with a cellular mobile phone communications network by a mobile connection 107 using a cellular base station 103. When a call is received at the mobile phone 106, the mobile phone comprises means for forwarding the call to the wireless headset 105. Therefore, the user may receive the call without, for example, touching the mobile phone 104. The wireless headset 105 comprises means for acknowledging the reception of the call. Furthermore, in the event that user wishes to make a call, he can partly activate the calling procedure by using the mere wireless headset 105.

The short-range wireless communications network 100 is also depicted in various further embodiments of FIG. 1. The short-range wireless communications network 100 comprises base stations 101′ to 101″ and a centralized controlling server 110. The short-range wireless communications network 100 can be based on Bluetooth communication in the base stations 101, 101′, and 101″.

Still referring to various embodiments of FIG. 1, the mobile phone 104 comprises means for detecting the wireless radio connection 106 between the mobile phone 104 and the wireless headset 105. When the wireless headset 104 is within the radio range coverage of the short-range wireless connection 106, the mobile phone 104 is aware of availability of the wireless headset 105 so that when the mobile phone 104 receives the call, a call forwarding unit can route the call to the wireless headset 105. Furthermore, when the wireless headset 105 attempts to make a call, the mobile phone 104 is able to forward and perform the call towards the cellular mobile communications network 103,107.

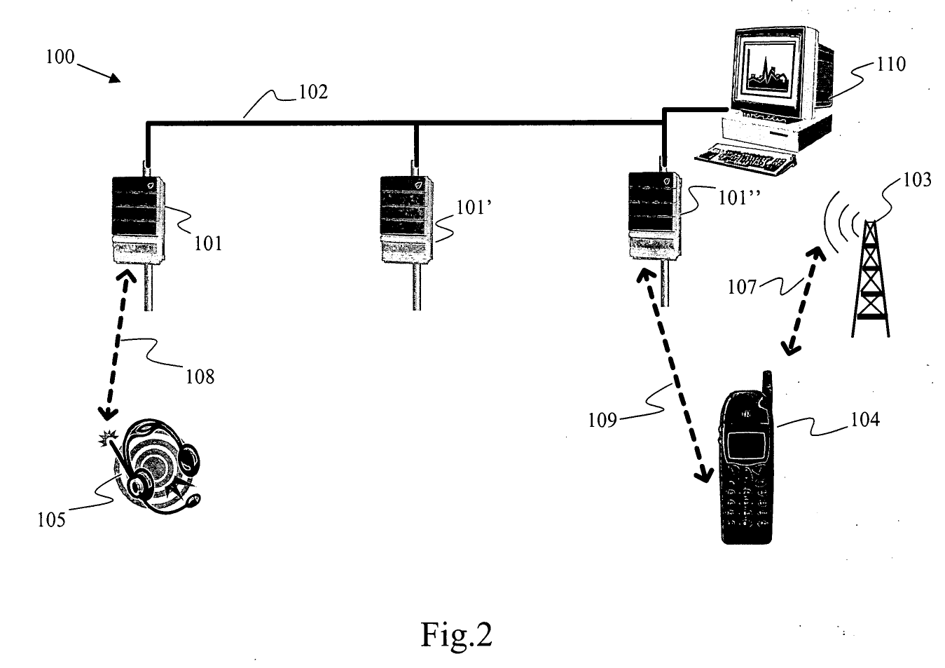

FIG. 2 depicts an example, where the mobile phone 104 and the wireless headset 105 have no direct short-range radio connection 106 and the connection is routed between the mobile phone 104 and the wireless headset 105 via a short-range wireless communications network 100 in accordance with various further embodiments of the invention. In various further embodiments, when the wireless headset 105 is out of the short-range wireless radio connection 106 in FIG. 1 (alternatively referred to as a range), the system can route the call between the mobile phone 104 and the wireless headset 105. The system in various further embodiments comprises generally three elements:

The mobile phone 104 or the like (alternatively the mobile phone can be referred to as a User Equipment (UE) as indicated in the mobile technology standardization documents). The mobile phone 104 is generally supervising the wireless connection 106 between the mobile phone 104 and the wireless headset 105. If the wireless headset 105 goes out of the range, the mobile phone 104 comprises means for detecting that the wireless headset 105 is out of the range. If the mobile phone 105 detects that the wireless headset 105 is out of the range, the mobile phone 105 connects 109 to the short-range wireless network 100. The connection 109 comprises a short-range radio communication connection between the mobile phone 104 and the base station 101″. In various further embodiments the short-range wireless network 100 can be a compatible indoor office network. In case of an incoming or outgoing call, the mobile phone 104 comprises means for routing the call via the short-range wireless office network 100. Furthermore the network 100 comprises the centralized server computer 110 that can take part to the routing process. Various further embodiments about the routing possibilities are described further.

Accordingly, when the user wearing the wireless headset 105 is out of the range 106, he is able to make the call via the short-range wireless network 100. Furthermore, when the incoming call is coming, the mobile phone 104 along with the network 110 can forward and route the call to the wireless headset 105.

Various further embodiments of the system comprise also the short-range wireless network 100. For example, the network 100 can provide an indoor coverage for an office area. A low-power radio interface 108,109 provides the network with connection to the mobile phone 104 and to the wireless headset 105. An example of the low-power radio interface is Bluetooth. The network coverage can be ensured by properly placed base stations 101,101′,101″. Each base station comprises the low-power radio transceiver. It is of course noted that the mobile phone 104 and the wireless headset 105 contain also the low-power radio transceiver.

Referring to the various further embodiments of FIG. 2, a backbone network 102 links the base stations 101,101′,100″. The implementation of the backbone network 102 can be provided by a number of different means (a proprietary solution, IP-based communications, 3GPP-based communications, even wire-based or wireless communications). The backbone networks couples the base stations 101,101′,101″ and the centralized controlling server 110 with each other.

Still referring to various further embodiments of FIG. 2, the incoming or outgoing phone calls, for example a call control and audio data, can be routed via the network 100 to the base station 100 closest to the wireless headset 105 to minimize the transmission power between the wireless headset 105 and the network base station 100. The network 100 provides the wireless headset 105 detection and handover functionality, e.g. by using the centralized controlling server 110. Further embodiments about the routing and forwarding follow.

The wireless headset 105 is a typical low-power device (e.g. Bluetooth), light and convenient to wear. While moving within the network's 100 coverage, there is a connection between the wireless headset 105 and the short-range wireless network base station 100,100′,100″.

Various Further Implementations

Various further embodiments can be embodied in networks available in most offices that can be used as a backbone network (e.g. Ethernet, WLAN, UMTS, GSM/GPRS). Furthermore the conventional wireless base stations (like UMTS, GSM/GPRS, WLAN, etc.) can be upgraded if wanted to provide the headset-compatible wireless network. For example, a Bluetooth chip can be added to mini base stations intended for indoor use. Another example is to use combined WLAN/Bluetooth chipsets/base stations when deploying WLAN networks.

For the mobile phone 104 to the wireless headset 105 connection, Bluetooth is one of the preferred embodiments. The same applies for the short-range wireless network bases station 101,101′,101″ to the mobile 104 and/or to the headset 105 connections. However, it should be noted that the invention is not limited to Bluetooth but alternatives can be used (such as low-power-WLAN, other low-power-RF interfaces).

There are various further implementations for the base stations 100,100′,100″:

A normal office PC can be provided with add-on Bluetooth transceivers (e.g. USB dongles). A Windows or Linux software serves furthermore as the base stations 101,101′101″ along with the add-on transceiver. One PC can serve as the controller 110. The wired IP Ethernet is used as the backbone network 102. A low-cost and/or low-effort implementation alternative can thus be provided.

In various further implementations the wireless office network base stations 101,101′,101″ can be provided by a standalone or by combined WLAN/UMTS/GSM base stations. For WLAN, an existing IP-based backbone can serve as the backbone network 102. For UMTS/GSM, the cellular core network can be used, or some base stations have a secondary IP network connection already, which can be re-used. A more effective network implementation can thus be provided.

For embodying the control of the short-range wireless network 100, there are various possibilities. For a low-cost/low-effort implementation the regular office PCs can be used and benefit from their operating system's support for most low-level functions (such as TCP/IP stack, LAN drivers, Bluetooth drivers etc.). Furthermore microcontrollers or dedicated hardware can be used for more effective implementation.

For the backbone network 102, some of the various implementation alternatives are wired Ethernet, WLAN (wireless Ethernet), WCDMA/GSM core network, Bluetooth LAN. Even scatternets (“active nodes”, no physical network infrastructure required) can be possible.

Various Further Embodiments Provide Routing and Forwarding of the Call

The mobile phone 104 operates the routing of the call between the mobile communications network 103,107 and the short-range wireless network 100. The network 100 contains a counter element such as an intelligent router, which is retrievable by a broadcast query or a query. The router contains a location register, which maintains or keeps track on the location of the wireless headset 105 within the network 100. Thus the location register contains information about the closest base station 100 for the headset 105. Accordingly, the router is the same to the mobile phone 104 during the whole routing process independently of the location of the headset 105 within the network 100. The router can be located at the centralized controlling server 110.

In yet another further embodiment, the mobile phone 104 operates the routing of the call between the mobile communications network 103,107 via the short-range wireless network 100 all the way to the short-range radio base station 101. The network 100 contains the counter element such as the location register, which should be retrieved by a broadcast query or a query. Also a closest/nearest base station 100 is now directly inquired from the location register. It should be noted that by signalling, the location of the headset 105 is tracked between the headset 105 and the mobile phone 104, if the headset 105 travels so that the base station 100 is changed to another closest one.

In yet another further embodiment, the mobile phone 104 operates also the routing of the call between the mobile communications network 103,107 via the short-range wireless network 100 all the way to the short-range radio base station 101. In this embodiment, the mobile phone 104 operates the headset 105 discovery, i.e. discovering the closest base station 100 to the headset 105, by signalling. However relatively heavy signalling load is now required.

Thus generally the network 100 maintains and keeps record the closest base station 100 to the headset 105. Thereby the location of the headset is also known if it is somehow needed. The location register maintains the recoded information about the location. Furthermore the location register takes part in pairing the headset 105.

In some embodiments, audio frames from/to the mobile communications network are converted as being such that they can be routed. For example by voice-IP. The mobile phone 104 can contain means (or software) for converting the frames, like Bluetooth PAN profile. Also the network 100 may have such a converter. Furthermore, the mobile phone 104 may operate transcoding, thus convert for example from AMC codec to PCM codec or the like.

Thus in various further embodiments, the mobile phone 104 contains the forwarding unit, alternatively referred to as the routing unit. This can be implemented by software.

Ramifications and Scope

Although the description above contains many specifics, these are merely provided to illustrate the invention and should not be construed as limitation of the invention's scope. It should be noted that the many specifics can be combined in various ways in a single or multiple embodiments. Thus it will be apparent to those skilled in the art that various modifications and variations can be made in the apparatuses and processes of the present invention without departing from the spirit or scope of the invention.

What is claimed is:

1. An apparatus for routing a call between a mobile phone and a wireless headset, the apparatus comprising:
a forwarding unit for routing said call between said mobile phone and said wireless headset via a short-range wireless communications network when said wireless headset is out of a range of a short-range radio transceiver of said mobile phone.

2. An apparatus according to claim 1, wherein said apparatus further comprises means for detecting a short-range wireless radio connection between said mobile phone and said wireless headset so that when said headset is out of said range, said forwarding unit can route said call.

3. An apparatus according to claim 1, wherein said forwarding unit comprises means for routing said call between said mobile phone and said wireless headset via said short-range radio transceiver when said wireless headset is within said range.

3. An apparatus according to claim 1, wherein said short-range wireless communications network comprises a plurality of base stations, each base station comprising a short-range radio transceiver, wherein each short-range radio transceiver can communicate said call with said wireless headset.

4. An apparatus according to claim 3, wherein the network further comprises means for detecting a strongest short-range radio connection from a plurality of connections between said wireless headset and said plurality of base stations.

5. An apparatus according to claim 4, wherein said strongest short-range radio connection is the only connection between one of the base stations and said wireless headset.

6. An apparatus according to claim 4, wherein the network further comprises means for detecting the closest base station for the wireless headset based on the detected strongest short-range radio connection.

7. An apparatus according to claim 6, wherein said forwarding unit further comprises means for forwarding said call to the closest base station.

8. An apparatus according to claim 3, wherein said network further comprises a controller coupled with the base stations.

9. An apparatus according to claim 8, wherein said controller comprises means for detecting a strongest short-range radio connection from a plurality of connections between said wireless headset and said plurality of base stations.

10. An apparatus according to claim 9, wherein said controller comprises a location register for maintaining a location of said wireless headset within said network based on the detected strongest short-range radio connection.

11. An apparatus according to claim 1, wherein said short-range wireless communication comprises a low-power radio communication such as Bluetooth.

12. A mobile phone for routing a call between said mobile phone and a wireless headset, the mobile phone comprising:
a forwarding unit for routing said call between said mobile phone and said wireless headset via a short-range wireless communications network when said wireless headset is out of a range of a short-range radio transceiver of said mobile phone.

13. A network element for routing a call between a mobile phone and a wireless headset, the network element comprising:
a forwarding unit for routing said call between said mobile phone and said wireless headset via a short-range wireless communications network when said wireless headset is out of a range of a short-range radio transceiver of said mobile phone.

14. A system for routing a call between a mobile phone and a wireless headset, the system comprising:
the mobile phone for detecting a short-range wireless connection between said mobile phone and said wireless headset;
a short-range wireless communications network for coupling said call between said mobile phone and said wireless headset; and
a forwarding unit for routing said call between said mobile phone and said wireless headset via said short-range wireless communication network when said wireless headset is out of a range of said short-range radio connection.

15. A method for routing a call between a mobile phone and a wireless headset, the method comprising:
routing, by a forwarding unit, said call between said mobile phone and said wireless headset via a short-range wireless communications network when said wireless headset is out of a range of a short-range radio transceiver of said mobile phone.
